(19) United States
(12) Patent Application Publication
(10) Pub. No.: US 2008/0099222 A1
(43) Pub. Date: May 1, 2008

(54) Power Tool And Vibration Damper

(76) Inventors: Ulrich Ranger, Leinfelden-Echterdingen (DE); Gerhard Meixner, Filderstadt (DE); Klaus Dietz, Filderstadt (DE); Juergen Schlipf, Leonberg (DE); Huber Steinke, Leinfelden-Echterdingen (DE); Christian Koepf, Denkendorf (DE)

Correspondence Address: MICHAEL J. STRIKER, 103 EAST NECK ROAD, HUNTINGTON, NY, 11743, US

(21) Appl. No.: 11/814,403

(22) PCT Filed: Aug. 14, 2006
(86) PCT No.: PCT/EP06/65285

§ 371 Date: Jul. 20, 2007

(30) Foreign Application Priority Data
Sep. 28, 2005 (DE) 10 2005 046 432.7

(51) Int. Cl. B25D 17/00

(52) U.S. Cl. 173/162.2

(57) ABSTRACT

The invention relates to a power tool comprising a housing (10) and a handle element (11) composed of a gripping member (12) and two lateral elements (13, 14) extending from the gripping member (12) to the housing (10). According to the invention, the handle element (11) is configured to pivot about a pivoting axis (15) that runs parallel to the longitudinal extension (27) of the gripping member (12). The invention also relates to a vibration damping device.

### PRIOR ART

The invention is based on a power tool and on a vibration damper as generically defined by the preambles to the independent claims.

When handheld power tools are in operation, unpleasant vibration occurs, especially in the region of the handle, because of the vibrating behavior of the tool. Such vibration leads to user fatigue sooner, and to a lessening of the holding forces. Especially in long-term operation, as with sanders, a user experiences an increased health risk. To attain good vibration damping and adequate guidance rigidity, various vibration damping systems are known in the prior art. Typically, absorbent coatings are used, or a damping suspension of the housing parts in the handle region is provided, for instance by way of rubber elements that make various movement directions possible, for reducing vibration.

In addition, handles of power tools, especially hooplike handles, are damped in the prior art by way of pivot joints and springs, and a pivoting direction is embodied transversely to the handle, or in other words substantially in the working direction.

### ADVANTAGES OF THE INVENTION

A power tool according to the invention includes a housing as well as a pivotably embodied handle element with a handle crossbar and two lateral elements leading from the handle crossbar to the housing; a pivot axis is located parallel to the longitudinal direction of the handle crossbar. This advantageously furnishes a simple, compact vibration damper in which the pivot axis is favorably located in such a way that good tool guidance is made possible.

In a vibration damper of the invention of a handle element of a power tool, the handle element is embodied pivotably about a predetermined pivoting radius substantially transversely to the working direction. As a result, work that is comfortable, with a secure grip and without causing fatigue, in the hand, arm, and shoulder region is made possible. Moreover, the embodiment proposed is suitable for two-handed operation on the hooplike handle. Because of the location according to the invention of the pivot axis, especially good, well-defined and precise guidance of the tool is possible, while at the same time a preferred vibration damping is attained. The proposed pivot axis favorably makes a virtually linear guidance possible, since the handle crossbar of the handle element behaves identically over its entire width. In addition, the tool can expediently be guided with both hands, without thus impairing the defined guidance of the tool.

Preferably, a maximum pivoting radius is defined by a first and a second turning point of the handle element, and the turning points are definable by means of a position of stop shafts, located toward the housing, of the lateral elements. It may be provided that the stop shafts are embodied as pivotable about the pivot axis, between a first and a second stop edge of the housing. In particular, the handle element can be located in the first turning point, when the stop shaft is in contact with the first stop edge. A preferred location of the handle element in second turning point occurs whenever the stop shaft is in contact with the second stop edge. Preferably, the first stop edge is then embodied vertically to the pivot axis, and the second stop edge is embodied obliquely to the pivot axis. In a preferred working position, the stop shaft is located approximately centrally between the first and second stop edges, and as a result the handle crossbar is located in a preferentially damped region. The result is especially favorable vibration damping.

The handle element may have axles at its pivot point that are each held in a respective pivot bearing of the housing. It may be provided that a damping element is joined to the pivot bearings on the axles. The damping element may for instance be formed of rubber elements that are joined to the axles elastically and in a manner fixed against relative rotation. Thus a compensation between a relative motion of the axles and the housing can be favorably attained. Preferably, the damping elements are prestressed in such a way that the handle crossbar, in the position of repose, is kept at the first turning point. If the handle crossbar of the handle element is compressed too severely, then the stop shaft comes into contact with the second stop edge, whereupon the end of the damped region is attained. In a preferred working position, the handle crossbar is located and pivoted approximately centrally between the first and the second turning point.

With the power tool embodied according to the invention, not only is a favorable connection between the handle element and the housing made that allows a relative motion, but also a preferred torsion spring action is attained, with the property that a moment proportional to the relative angle of rotation counter to the direction of motion occurs. For vibration damping of the vibration damper, damping elements may preferably be provided, but still other elements for a torsion spring action, such as steel springs, may also be provided.

The power tool with the vibration damper of the invention is quite clearly visible to the user from outside and is favorably noticeable as a substantial visual characteristic.

The provisions according to the invention can preferably be employed with power tools that are used in different working positions, while simple, ergonomic handling in particular is preserved.

### DRAWINGS

Further embodiments, aspects and advantages of the invention will become apparent even independently of their combination in claims, without limiting their general applicability, from exemplary embodiments of the invention described below in conjunction with drawings.

In the following:

FIG. 1 shows a front view of a preferred embodiment of a power tool of the invention with a vibration damper; and

FIG. 2 is a side view of the illustration in FIG. 1.

### DESCRIPTION OF THE EXEMPLARY EMBODIMENT

Identical elements are identified by the same reference numerals throughout the drawings.

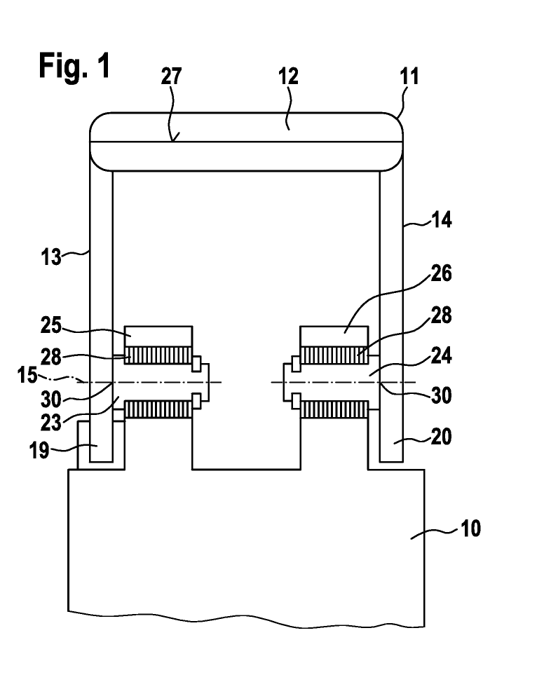

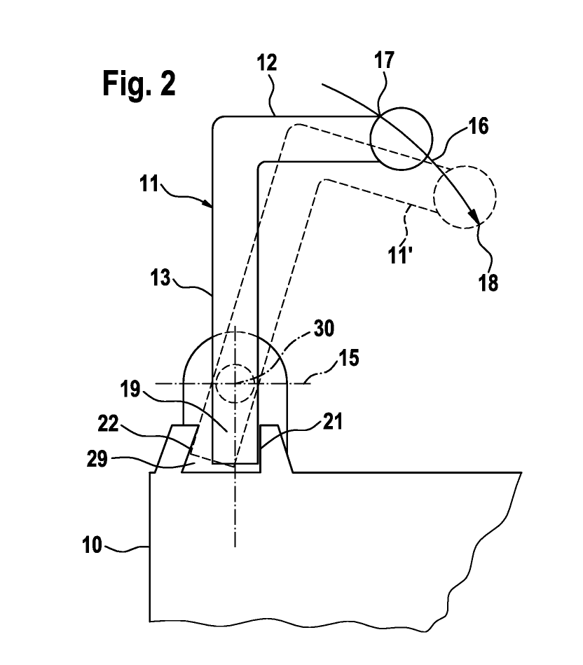

A preferred embodiment of a power tool, not shown in the drawings, with a housing 10 and a handle element 11 is shown in a front view in FIG. 1 and in a side view in FIG. 2. The handle element 11 is embodied as a hooplike handle and includes a handle crossbar 12 and two lateral elements 13, 14 that lead from the handle crossbar 12 toward the housing 10. The lateral elements 13, 14, in a position of repose shown in FIG. 1, point in the working direction. The handle element 11 has axles 23, 24 at its pivot points 30, and each axle is retained in a respective pivot bearing 25, 26 of the housing 10. The pivot bearings 25, 26 have damping elements 28, on the axles, in the form of rubber elements that make an elastic connection, in a manner fixed against relative rotation, with the axles 23, 24. The damping elements 28 are provided for the purpose of vibration damping and form an essential component of the vibration damper of the invention.

A desired torsion spring action of the vibration damper is attained by providing that the handle element 11 is embodied pivotably at the pivot point 30 about a pivot axis 15. The pivot axis 15 is located parallel to a longitudinal direction 27 of the handle crossbar 12. A pivoting radius 16 of the handle element 11 is limited, and the maximum pivoting radius 16 is located in particular between a first turning point 17 and a second turning point 18.

The turning points 17, 18 are definable by a position of stop shafts 19, 20 of the lateral elements 13, 14. The stop shafts 19, 20 thus form an extension, toward the housing, of the lateral elements 13, 14 and are located between the pivot point 30 and the housing 10 of the power tool.

From FIG. 2, it can be seen that the stop shafts 19, 20 are embodied pivotably about the pivot axis 15 between a first stop edge 21 and a second stop edge 21 of the housing 10. The handle element 11 is located at the first turning point 17, when the stop shaft 19 is in contact with the first stop edge 21 located toward the housing. The handle element 11 is located at the second turning point 18, when the stop shaft 19 is in contact with the second stop edge 22. The stop edges 21, 22 thus define a pivoting radius of the stop shafts 19, 20 that corresponds to the pivoting radius 15 of the handle element 11 between the first turning point 17 and the second turning point 18.

The first stop edge 21 is embodied in particular vertically to the pivot axis 15, and the second stop edge 22 is located obliquely to the pivot axis 15. The result in cross section is a trapezoidal notch 29 in the housing 10, within which the stop shaft 19 or 20 of the handle element 11 is movable.

The damping element 28 is prestressed in such a way that the handle crossbar 12 of the handle element 11, in a position of repose, is kept at the first turning point 18. In FIG. 2, the handle element 11 shown in solid lines is in the position of repose, while the handle element 11′ shown in dashed lines is located at the second turning point 18, whereupon the end of the damped region is attained. In a preferred working position, not shown, the stop shaft 19 is located approximately centrally between the first and second stop edges 21, 22, and as a result the handle crossbar 12 is approximately in a position that is located centrally between the first and second turning points 17, 18. In this position, an especially vibration damping action is attained.

1. A power tool, having a housing (10) and a handle element (11) that includes a handle crossbar (12) and two lateral elements (13, 14) leading from the handle crossbar (12) to the housing (10), characterized in that the handle element (11) is embodied pivotably, and a pivot axis (15) is located parallel to a longitudinal direction (27) of the handle crossbar (12).

2. A power tool as defined by claim 1, characterized in that a maximum pivoting radius (16) is defined by a first and second turning point (17, 18) of the handle element (11), and the turning points (17, 18) are definable by a position of stop shafts (19, 20), located toward the housing, of the lateral elements (13, 14).

3. A power tool as defined by claim 1, characterized in that the stop shafts (19, 20) are embodied pivotably about the pivot axis (15) between a first and a second stop edge (19, 20) of the housing (10).

4. A power tool as defined by claim 3, characterized in that the first stop edge (21) is embodied vertically to the pivot axis (15).

5. A power tool as defined by claim 3, characterized in that the second stop edge (22) is embodied obliquely to the pivot axis (15).

6. A power tool as defined by claim 1, characterized in that the handle element (11) has axles (23, 24), which are each retained in a respective pivot bearing (25, 26) of the housing (10).

7. A power tool as defined by claim 1, characterized in that on the axles, a damping element (28) is joined to the pivot bearings (25, 26).

8. A power tool as defined by claim 6, characterized in that the axles (23, 24) are joined to the damping element (28) in a manner fixed against relative rotation.

9. A power tool as defined by claim 7, characterized in that the damping element (28) is prestressed in such a manner that the handle crossbar (12), in the position of repose, is kept at the first turning point (18).

10. A vibration damper of a handle element of a power tool, characterized in that the handle element (11) is embodied pivotably, substantially transversely to the working direction, by a predetermined pivoting radius (16).

11. The vibration damper as defined by claim 10, characterized in that for the vibration damping, a damping element (28) is provided.

12. The vibration damper as defined by claim 10, characterized in that for the vibration damping, a steel spring is provided.
